(19) United States
(12) Patent Application Publication
(10) Pub. No.: US 2011/0224873 A1
(43) Pub. Date: Sep. 15, 2011

(54) VEHICLE ASSEMBLY CONTROLLER WITH AUTOMATON FRAMEWORK AND CONTROL METHOD

(76) Inventors: David R. Reeve, Chapel Hill (AU); Malcolm B. Jones, Bracken Ridge (AU); Andreas F. Ramm, Deception Bay (AU)

(21) Appl. No.: 12/883,985

(22) Filed: Sep. 16, 2010

Related U.S. Application Data
(60) Provisional application No. 61/243,475, filed on Sep. 17, 2009.

(51) Int. Cl. G06F 19/00; B62D 6/00

(52) U.S. Cl. 701/41; 701/1; 701/50

(57) ABSTRACT

The present invention relates to a controller for controlling the behavior of a vehicle assembly. The controller includes at least one processor coupled to ports. The ports are suitable for connecting to at least one sensor assembly and at least one actuator assembly of the vehicle assembly. The controller also includes memory containing a software product including computer readable instructions for execution by the processor. The processor executes the instructions so as to define automatons for performing respective behaviors when controlling the vehicle assembly. The present invention also relates to a method for controlling a vehicle assembly.

### CROSS-REFERENCE TO RELATED APPLICATION

This application is related to U.S. Provisional Patent Application Ser. No. 61/243,475 for GNSS Integrated Multi-Sensor Control System and Method, which is incorporated herein by reference.

### TECHNICAL FIELD

The present invention generally relates to a controller for controlling the behavior of a vehicle assembly. The present invention has particular, although not exclusive, application to controllers for agricultural vehicle assemblies.

### BACKGROUND

The reference to any prior art in this specification is not, and should not be taken as an acknowledgement or any form of suggestion that the prior art forms part of the common general knowledge.

A combine harvester (or simply combine) is a machine that harvests grain crops, and typically has a grain storage hopper of 150-320 bushel storage capacity. Upon filling the grain storage hopper, the combine would traditionally stop harvesting, travel some distance to a truck, and then unload the harvested grain into the truck.

In more recent times, a grain-cart assembly, e.g., an open-top trailer (grain cart) pulled by a tractor, has been used to unload the combine's hopper whilst the combine continues to harvest. In this manner, the tractor tows the grain-cart alongside the moving combine at speed whilst the combine unloads harvested grain into the grain-cart. Typical grain-carts generally range in size from about 500-1200 bushel storage capacity and can thereby store more grain than many combines. Once filled, the grain-cart is transported to a fleet of trucks for unloading.

In order to provide optimum harvesting efficiency, it is desirable that the combine continually harvests without interruption and does not need to stop harvesting to await the return of an unloaded grain-cart. Accordingly, the tractor operator must carefully choose combine unloading regions so that the combine isn't stopped and kept waiting. The tractor operator must judge and compensate for the combine speed which varies with crop density. Additionally, both the combine and tractor operators must adjust their relative ground speeds to evenly fill the grain-cart front to back as the grain-cart hopper reaches capacity. Although the operators can use 2-way radio communication and signal lights when they co-ordinate the ground speeds, human error associated with making critical decisions can adversely affect the efficiency and reliability of unloading the combine.

In addition, the tractor operator must judge the available time to unload the full grain-cart and return to the combine before the combine hopper is refilled. This task becomes increasingly difficult when supporting multiple combines with a single grain-cart. The tractor operator must also be conscious of the path he takes between the combine and trucks to minimize soil compaction and distance traveled. The tractor operator is faced with the pressure of making a number of critical and instantaneous decisions with a view of avoiding both the grain-cart being in the wrong place at the wrong time, and multiple random sets of heavily compacted grain-cart tracks across the field being harvested. It will be appreciated that a highly experienced tractor operator is required in order to maximize harvesting efficiency. However, in practice, the available workforce for the seasonal task of harvesting is limited.

### SUMMARY OF THE INVENTION

According to one aspect of the present invention, there is provided a controller for controlling the behavior of a vehicle assembly, the controller including: at least one processor coupled to ports for connecting to at least one sensor assembly and at least one actuator assembly of the vehicle assembly; and memory containing a software product including computer readable instructions for execution by the processor so as to define automatons (i.e., self-operating entities) for performing respective behaviors to control the vehicle assembly.

Each automaton may have:

an accepting interface for accepting requests from another automaton;

a requesting interface for making requests of another automaton;

a knowledge input for receiving a behavioral definition for affecting the behavior of the automaton;

a data input for receiving input data; and

a data output for sending output data.

In one embodiment, said knowledge input is capable of receiving the behavioral definition in real time and said data input is capable of receiving real time data. The controller may further include a storage device containing a spatial database including spatial data, said input data and output data being data which may be received from and output to the spatial database.

Each automaton may have an accepting interface for accepting a request from a delegator automaton, the accepting interface may be configured to:

accept a request for a behavior to be performed on behalf of the delegator automaton;

enable the automaton to act as a delegatee for performing the behavior on behalf of the delegator automaton; and

defer to the delegator automaton upon completion of the behavior or generation of an error.

Each automaton may have a requesting interface for making a request to a delegatee automaton, the requesting interface may be configured to:

seek the delegatee automaton to which to delegate a behavior;

delegate to the delagatee automaton to perform the behavior; and

listen for a deferral from the delegatee automaton upon completion of the behavior or generation of an error.

The controller may further include a storage device defining a register of possible behaviors, the storage device being located either onboard the controller or external to the controller and connected to the controller via a network, each automaton able to access said register to determine the delegatee automaton by evaluating which other automaton can most efficiently perform the behavior. The controller may further include one or more communications ports for receiving and/or transmitting data relating to the dynamic attitude (i.e., 3-D orientation, location and speed) of the vehicle assembly or implement thereof. The vehicle assembly may include a vehicle and an implement coupled to the vehicle.

The sensor assembly may include a hydraulics interface of a steering control assembly of the vehicle assembly, and the automatons may include:

a locomotion control executive automaton for receiving a user input and performing supervisory behavior of a proportional integral derivative (PID) automaton; and

the PID automaton for performing PID control and outputting a signal to the hydraulics interface.

According to another aspect of the present invention, there is provided a method for controlling a vehicle assembly carrying a controller, the controller including ports for connection to at least one sensor assembly and at least one actuator assembly of the vehicle assembly, the method including the step of executing computer readable instructions to define automatons for performing respective behaviors to control the vehicle assembly.

Each automaton may be configured to perform the steps of:

accepting requests from another automaton;

making requests to another automaton;

receiving a behavioral definition for affecting the behavior of the automaton;

receiving input data; and

sending output data.

In one embodiment, said behavioral definition and input data can be received in real time. Optionally, said input data and output data can be received from and sent to a spatial database.

Each automaton may be configured to perform the steps of:

accepting a request for a behavior to be performed on behalf of a delegator automaton;

acting as a delegate for performing the behavior on behalf of the delegator automaton; and

deferring to the delegator automaton upon completion of the behavior or generation of an error.

Each automaton may be configured to perform the steps of:

seeking a delegatee automaton to which to delegate a behavior;

delegate to the delagatee automaton to perform the behavior; and

listening for a deferral from the delegatee automaton upon completion of the behavior or generation of an error.

In one embodiment, each automaton can perform the step of determining the delegatee automaton by evaluating which other automaton can most efficiently perform the behavior. Optionally, the method may further include the step of receiving and/or transmitting with the controller, data relating to the dynamic attitude of the vehicle assembly or an implement thereof.

One of said automatons may be configured to perform the steps of receiving a user input and performing supervisory behavior of another automaton. The other automaton may be configured to perform the step of processing an input signal to generate an output signal.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram showing a tractor towing a grain-cart adjacent to a moving combine harvester;

FIG. 2 is a block diagram of a control system for controlling the tractor of FIG. 1, in accordance with an embodiment of the present invention;

FIG. 3 is a flowchart showing a control method performed by a controller of the control system of FIG. 2;

FIG. 4 is a schematic diagram showing an automaton arrangement for engaging control of the tractor during the method of FIG. 3;

FIG. 5 is a flowchart showing a method of behavior of the automaton arrangement of FIG. 4;

FIG. 6 is a state diagram showing the supervisory behavior of a delegator Locomotion Control Executive automaton of the automaton arrangement of FIG. 4;

FIG. 7 is a schematic diagram of a delegatee PID controller automaton of the automaton arrangement of FIG. 4; and

FIG. 8 is a schematic diagram of an automaton of the automaton arrangement of FIG. 4.

### DETAILED DESCRIPTION OF PREFERRED EMBODIMENTS

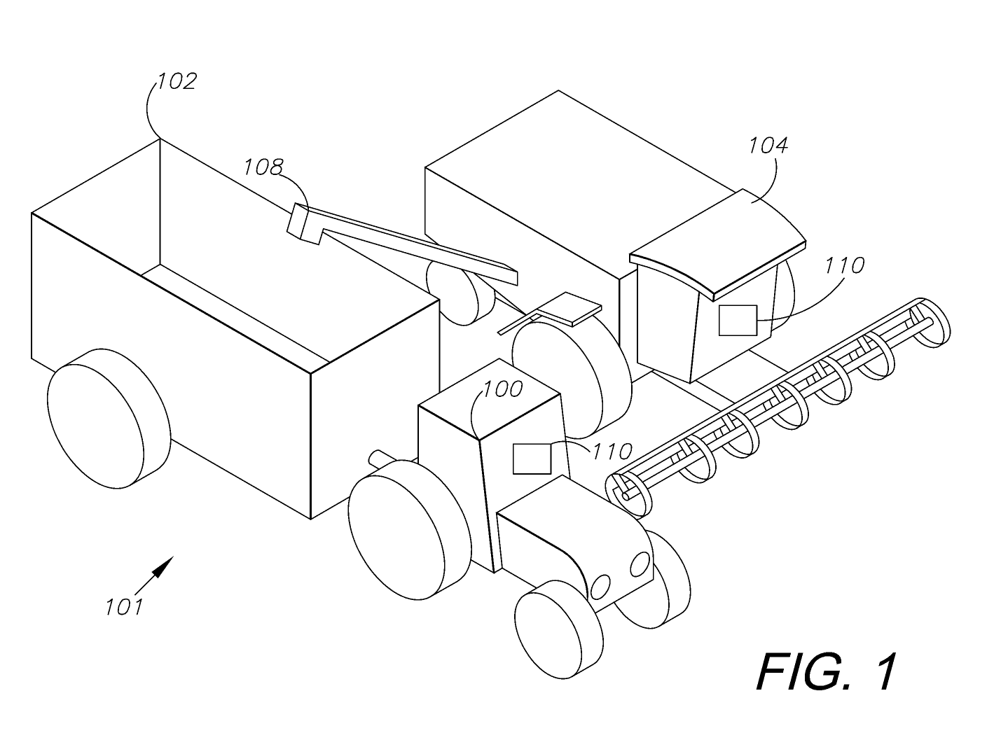

FIG. 1 shows a grain cart assembly 101 comprising a tow vehicle, e.g., a tractor 100, towing a grain-cart 102 adjacent to a moving combine harvester 104. The combine 104 can unload grain into the grain-cart 102 via the unloading auger 108 whilst the combine 104 continues to harvest. According to an embodiment of the present invention, there is provided a control system 110 for controlling the position of the tractor 100 (and therefore grain-cart 102) relative to the combine 104 during unloading. The control system 110 is located onboard the tractor 100, and can automatically control the steering and speed (i.e., dynamic attitude) of the tractor 100 to improve unloading efficiency of the combine 104. The control system 110 is capable of guiding and controlling an appropriate vehicle or implement connected to a vehicle. The control system 110 is adaptable for any such vehicle suitable for interfacing with and using a control system for guidance and operation of that vehicle. In the preferred embodiment, the combine 104 is also equipped with a control system 110 capable of controlling performance aspects necessary to the function of the combine.

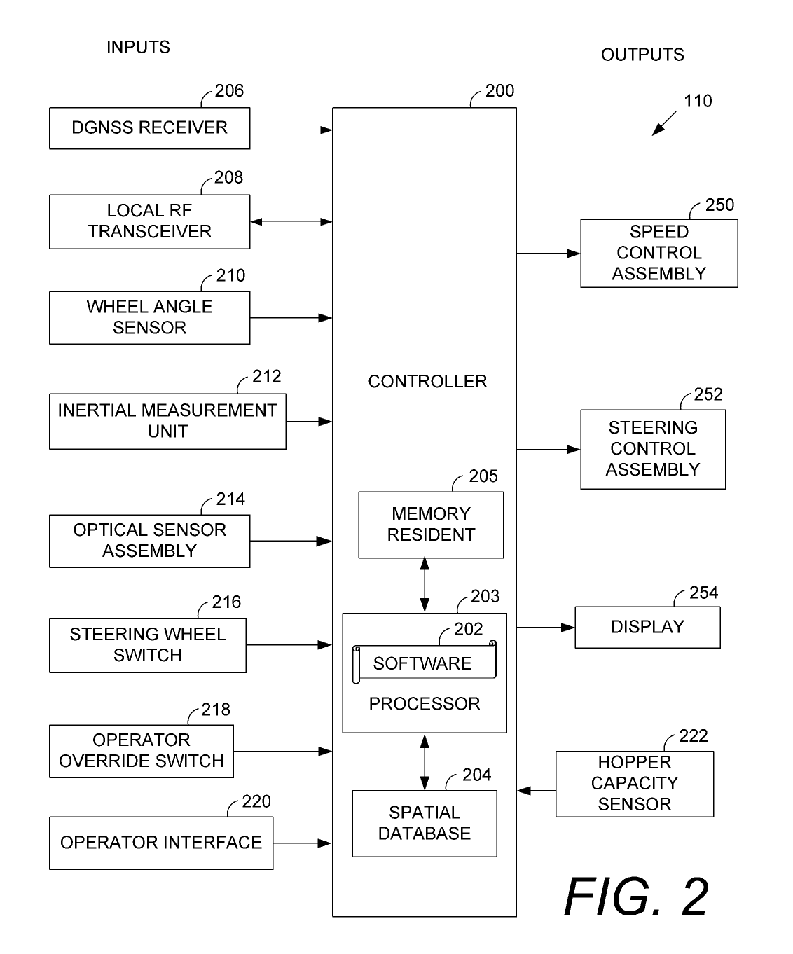

Turning to FIG. 2, the control system 110 includes a central controller 200 in which a software product 202 is contained in resident memory. In turn, the software product 202 contains computer readable instructions for execution by a processor 203 of the controller 200 to perform the methods outlined below. The processor 203 is interfaced to a storage device (e.g. hard disc) containing a memory resident 205, such as a utility program that loads and remains in random access memory (RAM) even when not running, in order to be available instantly when required, and a spatial database 204 which includes, among other data relating to the control system 110, geographical location information relating to the field being harvested by the combine 104. In use, the controller 200 uses this geographic information to control the tractor 100 as described in WO/2008/080193, which is incorporated herein by reference.

The processor 203 is electrically coupled to terminal ports for connecting to receiver 206, transceiver 208, sensor assemblies 210 to 222, and actuator assemblies 250, 252 of the tractor 100 towing the grain-cart 102.

Elaborating further, the control system 110 includes a differential global navigation satellite system (DGNSS) receiver 206 for sensing the location of the tractor 100. Global navigation satellite systems (GNSSs) are broadly defined to include the Global Positioning System (GPS, U.S.), Galileo (proposed, Europe), GLONASS (Russia), Beidou (China), Compass (proposed), the Indian Regional Navigational Satellite System (IRNSS), QZSS (Japan, proposed) and other current and future positioning technology using signals from satellites, with or without augmentation from terrestrial sources. The receiver 206 receives location information relating to the tractor 100 (and therefore the grain-cart 102) which the controller 200 uses to determine the tractor attitude and location components of the dynamic attitude that, in turn, is stored in the spatial database 204. The controller 200 can also determine the speed component of the dynamic attitude of the tractor 100 using this information.

A local radio frequency (RF) transceiver 208 transmits tractor 100 information to, and receives combine information from, another local RF transceiver carried by the combine 104. The tractor 100 information and combine information includes location data relating to the respective dynamic attitudes of the tractor 100 and the combine 104 (or implements thereof). The combine information further includes the combine's hopper fill rate and the combine's location. The controller 200 can use the received combine 104 information to control the relative position of the grain-cart 102. The tractor 100 information further includes a cease filling command which is sent to the combine 104 when the grain-cart 102 is full, responsive to which the combine 104 ceases filling the grain-cart 102.

The control system 110 further includes a wheel angle sensor 210 mounted to a wheel of the tractor 100. The wheel angle sensor 210 is coupled to the controller 200 so that the controller 200 can determine the wheel angle of the tractor 100. In addition, the control system 110 includes an inertial measurement unit (IMU) 212 which may include a gyroscope. The inertial measurement unit 212 is coupled to the controller 200 which, in turn, can determine the pitch, roll and yaw dynamic attitude components of the tractor 100.

An optical sensor assembly 214 can be coupled to the controller 200 so that the controller 200 can determine the lateral separation between the tractor 100 and the combine 104 when automatically controlling the tractor 100.

The control system 110 further includes safety inputs in the form of steering wheel switch 216 and operator override switch 218. The steering wheel switch is mounted to the steering wheel of the tractor 100. In the event that the tractor operator steers the steering wheel when the controller 200 is automatically controlling the steering and speed of the tractor 100, the controller 200 senses the actuation of the steering wheel switch 216 and then disables the automatic control of a steering control assembly of the tractor 100. In the event that the tractor operator triggers the override switch 218 when the controller 200 is automatically controlling the steering and speed of the tractor 100, the controller 200 senses the actuation of this switch 218 and then disables the automatic control of the steering control assembly and a speed control assembly of the tractor 100.

The control system 110 further includes an operator (or terminal) interface 220 in which the tractor operator can input operator commands to the controller 200.

The control system 110 further includes a grain-cart capacity sensor 222 coupled to the controller 200. The controller 200 can use readings from the capacity sensor 222 to determine the remaining capacity of the hopper of the grain-cart 104 (i.e. the remaining grain-cart capacity).

As previously indicated, the control system 110 includes two driven outputs in the form of tractor speed control assembly 250 and tractor steering control assembly 252. During automatic control of the tractor 100, the controller 200 controls the tractor speed control assembly 250 (including an accelerator of the tractor 100) so that the tractor 100 automatically travels at a desired speed. At this time, the controller 200 can also control the tractor steering control assembly 252 (including a steering valve block of the tractor 100) so that the tractor 100 is automatically steered.

The control system 110 further includes a display 254 controlled by the controller 200 and able to display information to the tractor operator. In particular, the display 254 can display a map of the field being harvested showing geographical features stored in the spatial database 204. In addition the display can show the relative positions of the tractor 100 and combine 104 on the map.

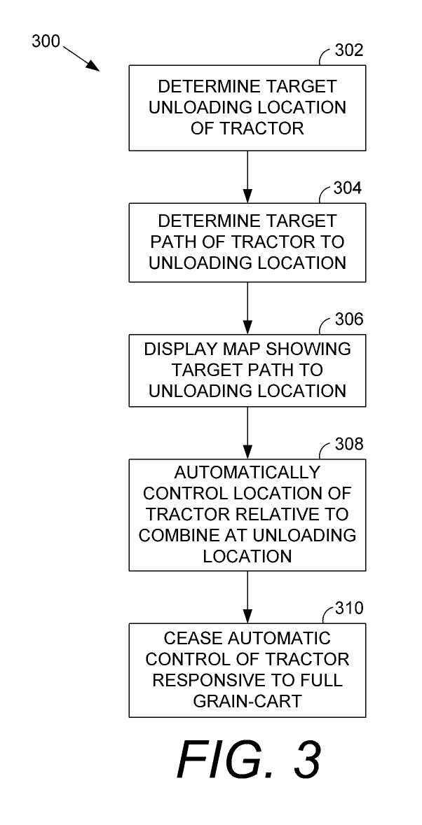

A control method 300 performed by the controller 200 executing software product 202 is shown in FIG. 3.

At step 302, the controller 200 determines a target unloading location where the tractor 100 can meet the moving combine 104 for receiving the harvest in the combine's hopper. The target unloading location can be determined using the combine's location and the combine's hopper fill rate received via local RF transceiver 208.

At step 304, the controller 200 determines a target path to guide the tractor 100 from its present location to the target unloading location, based upon operator commands input into the operator interface 220. The operator commands would typically include target path criteria including any one of the shortest target path distance, and the minimum compaction whereby the target path maximally intersects previous paths actually taken by the tractor to minimize field compaction.

At step 306, the controller 200 controls the display 254 to display the map, the locations of the tractor 100 and combine 104, and the target path. The controller 200 also controls the display 254 to display a required heading which the tractor operator can manually follow so that the tractor 100 follows the target path. In practice, the required heading corresponds to the required orientation of the tractor steering wheel.

The tractor operator simply controls the tractor 100 to follow the correct heading and is not faced with the pressure of making critical and instantaneous decisions related to the target path.

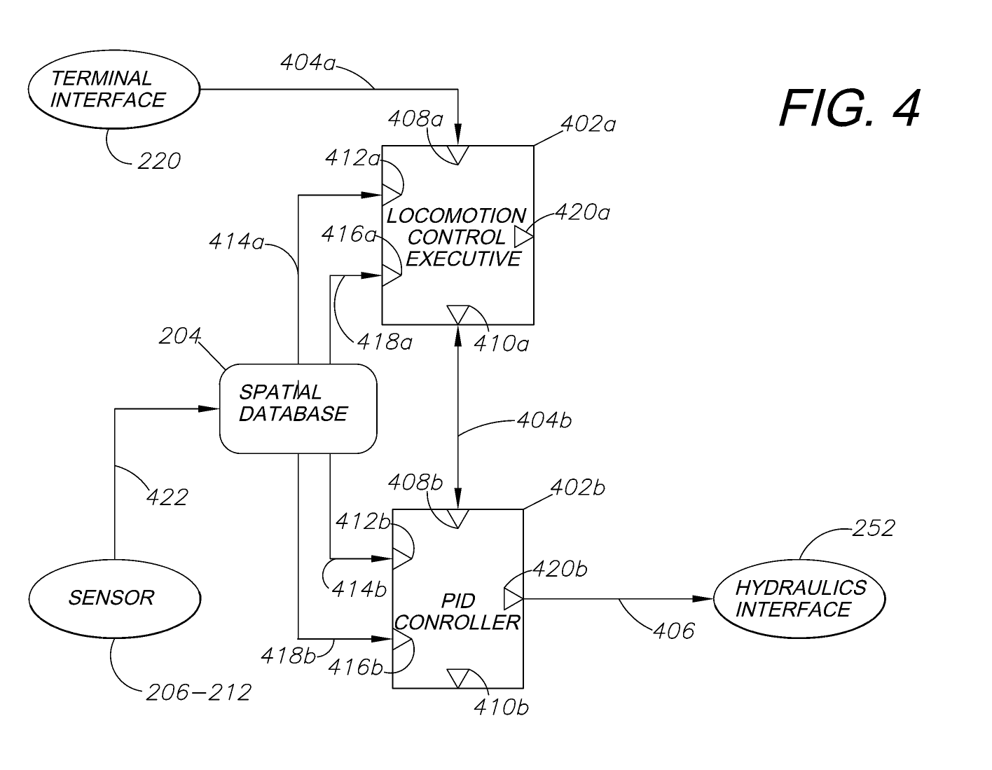

At step 308, the tractor operator inputs an automated control command into the operator interface 220 as the tractor 100 approaches the combine 104 at the target unloading location, and the controller 200 then automatically controls the position of the tractor 100 relative to the combine 104. During this step, the controller 200 controls the behavior of the tractor 100 by engaging control of the tractor 100, whereby the software product 202 defines automatons for performing respective behaviors when engaging control of the tractor 100. The method of engaging control of the tractor 100 is described in detail below with reference to FIGS. 4 to 7.

The controller 200 controls the speed control assembly 250 and steering control assembly 252 using: the tractor's dynamic attitude determined using received information via the DGNSS receiver 206, combine information received via RF transceiver 208, the tractor's wheel angle determined using wheel angle sensor 210, the tractor's pitch, roll and yaw determined using inertial measurement unit 212, and the lateral separation between the tractor 100 and the combine 104 determined using optical sensor assembly 214, all of which are stored in storage device containing spatial database 204.

The controller 200 can automatically control the position of the tractor 100 relative to the combine 104 so that the combine 104 uniformly fills the grain-cart 102. In this manner, the tractor operator need not face the pressure of making critical and instantaneous decisions relating to locating the grain-cart 102 in an optimum unloading position.

The controller 200 determines the grain-cart 102 capacity using the grain-cart capacity sensor 222 and further determines when the grain-cart capacity exceeds a predetermined threshold (thereby indicating that the grain-cart is full). Once the grain-cart 102 is full, the controller 200 sends the cease filling command to the combine 104 via RF transceiver 208, responsive to which the combine 104 ceases filling the grain-cart 102.

At step 310 the tractor operator inputs a manual control command into the operator interface 220 once the grain-cart 102 is full, and the controller 200 then ceases to automatically control the position of the tractor 100 relative to the combine 104. The tractor operator can then manually resume control of the tractor speed control assembly 250 and tractor steering control assembly 252.

The method of engaging control of the tractor 100 undertaken in step 308 above, is described below with reference to FIGS. 4 to 7.

FIG. 4 shows an automaton arrangement 400 for engaging control of the tractor 100. The automaton arrangement 400 is implemented using automata-based programming techniques. Automata-based programming is a programming paradigm in which the software program or its part can be thought of as a model of a finite state machine or any other formal automata. The automaton arrangement 400 includes two automatons 402a, 402b which are self-operating entities for performing respective behaviors. In particular, a locomotion control executive automaton 402a receives a user input request 404a from the operator interface 220 and performs supervisory behavior of a PID control automaton 402b. The PID control automaton 402b performs PID control and outputs desired curvature data 406 to a hydraulics interface of the steering control assembly 252.

Each automaton 402 has similar features including an accepting interface 408 for accepting requests 404 from another automaton 402 or the operator interface 220. In addition, each automaton 402 has a requesting interface 410 for making requests 404 to another automaton 402. A knowledge input 412 is configured to receive a behavioral definition 414 (e.g. state transition table which is a table containing information pertaining to states of the automaton 402, parameters, rules etc.) in real time for affecting the behaviour of the automaton 402. Each automaton 402 further includes a data input 416 for receiving input data 418 which can be in the form of real time data. Furthermore, each automaton 402 has a data output 420 for sending output data which can be, for example, in the form of desired curvature data 406 output to the steering control assembly 252.

The storage device containing the spatial database 204 is continually updated with sensor data 422 from sensors 206 to 212 and automatons 402 to provide a “real world view” of the field to be harvested by the harvester 104. In turn, the automatons 402 receive the behavioral definitions 414a, input data 414b, and course error input data 418b (representing the error between the tractor's actual and desired location and heading) from the spatial database 204 and use this “real world view” when performing their designated behavior. In addition, the automatons 402 can write the output data 406 to the spatial database 204.

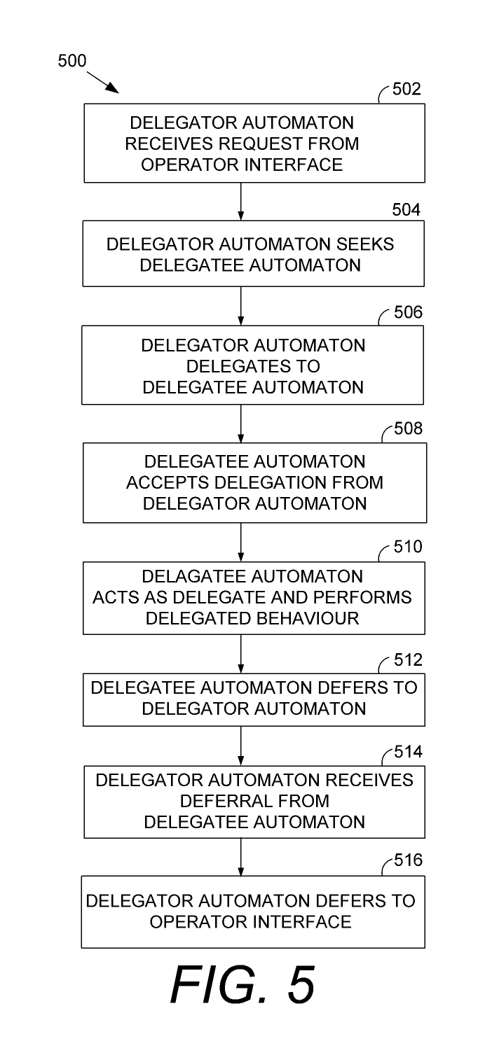

FIG. 5 shows a behavioral method of the automaton arrangement 400 to engage control of the tractor 100.

At step 502, the tractor operator inputs an operator command into the operator terminal interface 220 to engage control of the tractor 100. The accepting interface 408a of the delegator locomotion control executive automaton 402a receives a delegate request 404a from the operator interface 220.

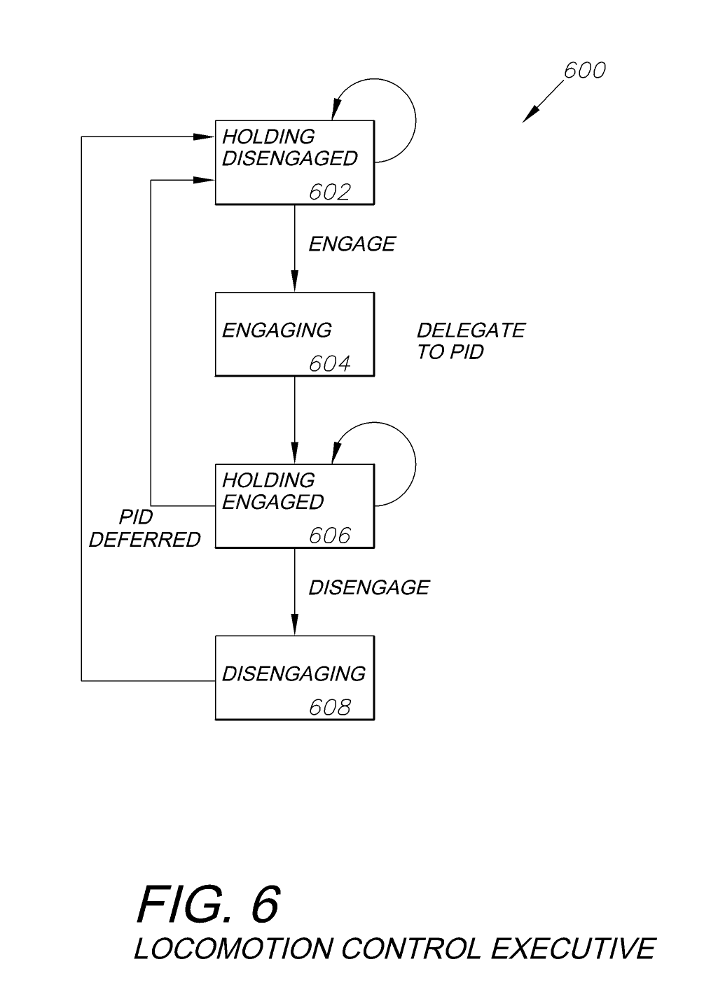

Behavioral definitions 414a of the delegator automaton 402a are loaded into knowledge input 412a from the spatial database 204. The supervisory behavior of the delegator automaton 402a is performed in accordance with the behavioral definitions 414a and is described in detail below with reference to FIG. 6.

In addition, boolean input data 418a is periodically loaded into data input 416a from the spatial database 204 and serves as an enable for enabling operation of the delegator automaton 402a.

At step 504, the delegator automaton 402a seeks the delegatee automaton 402b to which to delegate a PID control behavior. This step of seeking involves the delegator automaton 402a accessing a register of possible behaviors stored in the storage device 204 whereby each behavior entry in the register has efficiency indicators associated with respective automatons 402. The delegatee automaton 402b is determined from the available automatons 402 by evaluating which automaton 402 can most efficiently perform the PID control behavior based upon the stored efficiency indicators.

At step 506, the delegatee automaton 402b is determined and the delegator automaton 402a delegates the PID control behavior to be performed by the delagatee automaton 402b by sending a delegate request 404b from requesting interface 410a to accepting interface 408b.

At step 508, the delegatee automaton 402b accepts the delegate request 404b for the PID control behavior to be performed on behalf of the delegator automaton 402a.

At step 510, the delegatee automaton 402b is enabled to act as a delegate and performs the delegated PID control behavior (input via knowledge input 412b) on behalf of the delegator automaton 402a.

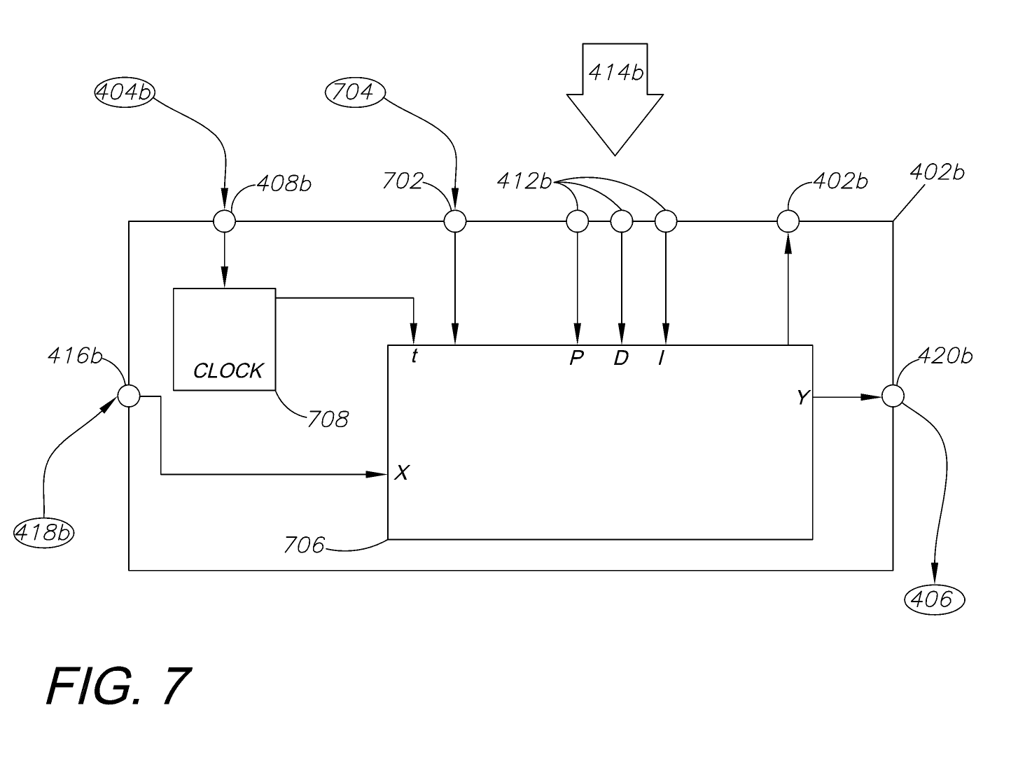

Behavioral definitions 414b (i.e. proportional, integral and derivative parameters) of the delegatee automaton 402b are provided into knowledge input 412b from the spatial database 204. The PID control behavior of the delegatee automaton 402b is performed in accordance with the behavioral definitions 414b and is described in detail below with reference to FIG. 7.

In addition, the course error input data 418b corresponding to the course error of the tractor 100 is provided into data input 416b from the spatial database 204. This input data 418b is processed by the PID control automaton 402b to produce output curvature data 406.

At step 512, the delegatee automaton 402b defers to the delegator automaton upon completion of the PID control behavior in the event of an error. In this manner, a defer request 404b is sent from accepting interface 408b to requesting interface 410a.

At step 514, the delegator automaton 402a listens and receives the deferral request 404b from the delegatee automaton 408b sent upon completion of the PID control behavior or generation of an error.

At step 516, the delegator automaton 402a sends a deferral request 404a to the operator interface 220 via accepting interface 408a confirming that the PID behavior has ceased.

FIG. 6 is a state diagram 600 showing the supervisory behavior of the delegator Locomotion Control Executive automaton 402a.

Referring to state 602, the delegator automaton 402a is initially held in a holding disengaged state 602. The delegatee automaton 402b is not engaged to perform PID control behavior.

Engaging state 604 is entered by the delegator automaton 402a, when the accepting interface 408a of the delegator automaton 402a receives a delegate request 404a from the operator interface 220 at step 502. The delegator automaton 402a seeks the delegatee automaton 402b and the delegator automaton 402a delegates the PID control behavior to be performed by the delagatee automaton 402b as explained above in steps 504 and 506. Next, the delegator automaton 402a enters holding engaged state 606.

Referring to state 606, the delegator automaton 402a is held in a holding engaged state 606. In the meantime, the delegatee automaton 402b accepts the delegate request 404b for the PID control behavior to be performed and performs the PID control behavior as indicated in steps 508 and 510.

In the event of an error as indicated in step 512, the delegatee automaton 402b defers to the delegator automaton 402a upon completion of the PID control (or generation of an error) and the delegator automaton 402a re-enters state 602 from state 606.

In the event of boolean input data 418a from the spatial database 204 reflecting a disablement, the delegator automaton 402a moves from holding engaged state 606 to disengaging state 608.

Referring to state 608, delegator automaton 402a revokes the delegatee automaton 402b. In this manner, a revocation request 404b is sent from requesting interface 410a to accepting interface 408b. In turn, the delegatee automaton 402b ceases its PID control behavior and the delegator automaton 402a moves from disengaging state 608 to holding disengaged state 602 once more.

FIG. 7 schematically shows the internal PID control behavior components of the delegatee PID controller automaton 402b.

The delegatee automaton 402b can have an additional enable input 702 which enables the PID control behavior responsive to an appropriate boolean signal 704 from the spatial database 204.

The delegatee automaton 402b has a PID controller core 706 which performs PID control of course error input data 418b to generate output curvature data 406. The PID control function is:

Y=PX−D∂x/∂t+IΣx∂t
where the proportional (P), integral (I) and derivative (D) parameters are received via knowledge input 412b; and
∂t, is a time increment from a timer 708 so that the automaton 402b is synchronous.

As previously described above in relation to steps 506 and 508, the timer 708 is enabled upon receipt of the delegate request 404b. The delegatee automaton 402b performs PID control behavior at step 510, taking periodic samples of the behavioural definitions 414b (i.e. proportional, integral and derivative parameters) and the course error input data 418b from the spatial database 204 which form the “real world view”. In turn, output curvature data 406 is used to steer the tractor 100 when output to the steering control assembly 252.

If an error occurs in transforming course error input data 418b to output curvature data 406 as described at step 512, the delegatee automaton 402b defers to the delegator automaton 402a whereby defer request 404b is sent from accepting interface 408b to requesting interface 410a. Furthermore, the delegatee automaton 402b internally disables the timer 708.

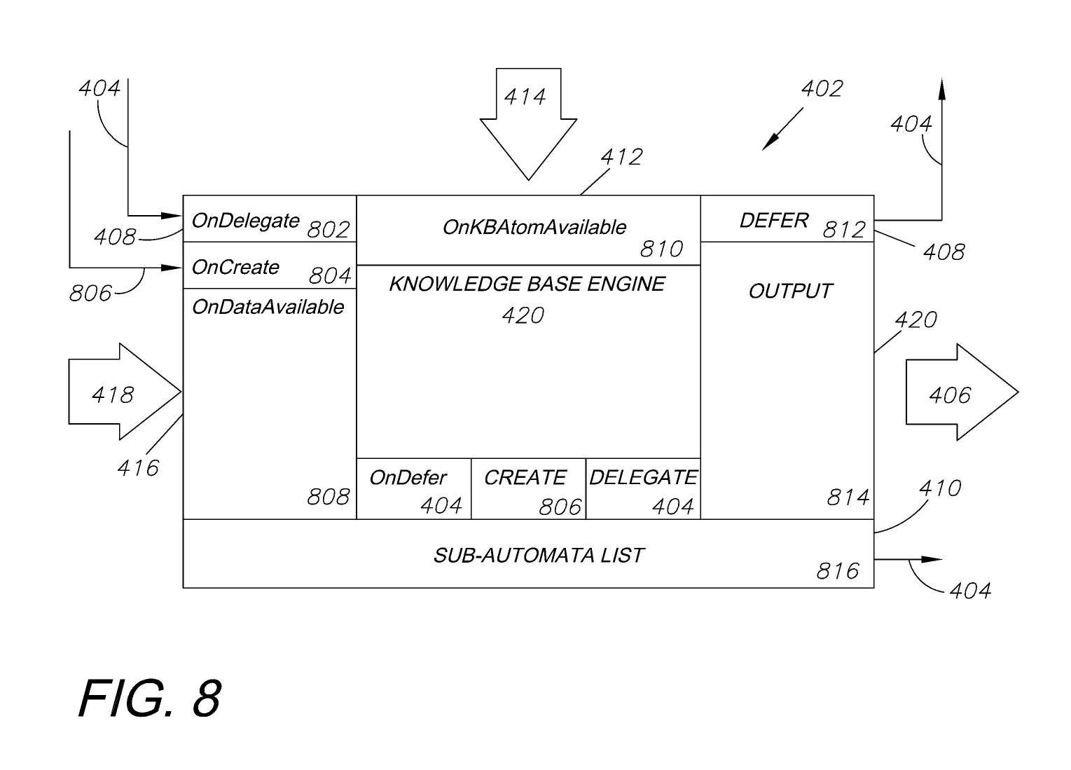

FIG. 8 shows the basic functional components of each automaton 402 where like reference numerals refer to like features previously described.

Each automaton 402 includes an on-delegate component 802 and an on-create component 804 for each receiving requests via accepting interface 408 from a delegator automaton 402. The on-create component 804 receives a create request 806 which effectively creates the automaton 402. The on-delegate component 802 receives a delegate request 404 as previously described. Each automaton 402 also includes a data-available component 808 which receives input data 418 via data input 416.

Each automaton 402 also includes a knowledge-available component 810 which receives a behavioral definition 414 via a knowledge input 412.

Each automaton 402 also includes a defer component 812 which sends a defer request 404 via accepting interface 408.

Each automaton 402 also includes an output component 814 which sends output data which can be, for example, in the form of desired curvature data 406 via data output 420.

Each automaton 402 also includes a sub-automata component 816 which can make (or receive) requests 404 to another sub-automaton 402 via requesting interface 410. The requests 404 may be in the form of a defer request 404 received from the sub-automaton 402, a create request 806 which when received the by the sub-automaton 402 effectively creates the sub-automaton 402, and a delegate request 404 as previously described.

Each automaton 402 also includes a knowledge base component engine 420 for controlling each of the other (surrounding) components 802, 804, 808, 810, 812, 814 and 816.

The above application of automaton relationships between two or more agricultural vehicles includes any and all disclosures located in U.S. Publication No. 2009/0164067 to Whitehead et al. titled Multiple-Antenna GNSS Control System and Method filed Jan. 17, 2009, the disclosures of which are incorporated by reference herein in their entirety.

A person skilled in the art will appreciate that many embodiments and variations can be made without departing from the ambit of the present invention.

FIG. 4 shows an automaton arrangement for engaging control of the tractor 100 which includes two automatons 402. It will be appreciated that other embodiments of the present invention involve automaton arrangements including more than two automatons 402 for performing respective behaviors.

The preferred embodiment was described with respect to a tractor assembly including a tractor 100 and a grain-cart 102 coupled to the tractor 100. In an alternative embodiment, the tractor assembly may include the tractor 100 coupled to an alternative type of implement such as a crop sprayer, for example. The controller could then be used to control the behavior of the sprayer of the vehicle assembly.

In the embodiment shown in FIG. 2, the storage device 204 is located within or onboard the controller 200. In another embodiment, the storage device 204 is instead remotely located external to the controller 200 and connected to the processor 203 via a network.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Having thus described the disclosed subject matter, what is claimed as new and desired to be secured by Letters Patent is:

1. A controller for controlling the behavior of a vehicle assembly, the controller including:
at least one processor coupled to ports for connecting to at least one sensor assembly and at least one actuator assembly of the vehicle assembly; and
memory containing a software product including computer readable instructions for execution by the processor so as to define automatons for performing respective behaviors to control the vehicle assembly.

2. A controller as claimed in claim 1, wherein each automaton has:
an accepting interface for accepting requests from another automaton;
a requesting interface for making requests to another automaton;
a knowledge input for receiving a behavioral definition for affecting the behavior of the automaton;
a data input for receiving input data; and
a data output for sending output data.

3. A controller as claimed in claim 2, wherein said knowledge input is capable of receiving the behavioral definition in real time and said data input is capable of receiving real time data.

4. A controller as claimed in claim 2, further including a storage device containing a spatial database including spatial data, said input data and output data being data which can be received from and output to the spatial database.

5. A controller as claimed in claim 1, wherein each automaton has an accepting interface for accepting a request from a delegator automaton, the accepting interface being configured to:
accept a request for a behavior to be performed on behalf of the delegator automaton;
enable the automaton to act as a delegate for performing the behavior on behalf of the delegator automaton; and
defer to the delegator automaton upon completion of the behavior or generation of an error.

6. A controller as claimed in claim 1, wherein each automaton has a requesting interface for making a request to a delegatee automaton, the requesting interface being configured to:
seek the delegatee automaton to which to delegate a behavior;
delegate to the delagatee automaton to perform the behavior; and
listen for a deferral from the delegatee automaton upon completion of the behavior or generation of an error.

7. A controller as claimed in claim 6, further including a storage device defining a register of possible behaviors, the storage device being located either onboard the controller or external to the controller and connected to the controller via a network, each automaton able to access said register to determine the delegatee automaton by evaluating which other automaton can most efficiently perform the behavior.

8. A controller as claimed in claim 7, further including:
a memory resident utility program that loads and remains in random access memory (RAM) for instant availability when required; and
said memory resident utility program adapted for delivering delegation commands to each automaton connected to the network and responding to delegation commands received from the delegating automaton.

9. A controller as claimed in claim 1, further including one or more communications ports for receiving and/or transmitting data relating to the dynamic attitude of the vehicle assembly or implement thereof.

10. A controller as claimed in claim 1, wherein the vehicle assembly includes a vehicle and an implement coupled to the vehicle.

11. A controller as claimed in claim 10, wherein the vehicle and coupled implement is comprised of a combine harvester and related implement.

12. A controller as claimed in claim 1, wherein said sensor assembly includes a hydraulics interface of a steering control assembly of the vehicle assembly, and said automatons include:
a locomotion control executive automaton for receiving a user input and performing supervisory behavior of a PID automaton; and
the PID automaton for performing PID control and outputting a signal to the hydraulics interface.

13. A method for controlling a vehicle assembly carrying a controller, the controller including ports for connection to at least one sensor assembly and at least one actuator assembly of the vehicle assembly, the method including the step of executing computer readable instructions to define automatons for performing respective behaviors to control the vehicle assembly.

14. A method as claimed in claim 13, wherein each automaton is configured to perform the steps of:
accepting requests from another automaton;
making requests to another automaton;
receiving a behavioral definition for affecting the behavior of the automaton;
receiving input data; and
sending output data.

15. A method as claimed in claim 14, including the steps:
providing a storage device defining a register of possible behaviors;
locating said storage device either onboard the controller or external to the controller and connected to the controller via a network; and
accessing said register with each automaton to determine the delegatee automaton by evaluating which other automaton can most efficiently perform the behavior.

16. A method as claimed in claim 15, including the steps of:
loading a memory resident utility program into said storage device, said utility program adapted for remaining in random access memory (RAM) for instant availability when required;
accessing said utility program with each automaton;
delivering behavioral definition and input data to each automaton connected to the network; and
responding to behavioral definition and input data received from the delegating automaton;
wherein said behavioral definition and input data can be received in real time.

17. A method as claimed in claim 15, wherein said input data and output data can be received from and sent to a spatial database.

18. A method as claimed in claim 13, wherein each automaton is configured to perform the steps of:
accepting a request for a behavior to be performed on behalf of a delegator automaton;
acting as a delegate for performing the behavior on behalf of the delegator automaton; and
deferring to the delegator automaton upon completion of the behavior or generation of an error.

19. A method as claimed in claim 13, wherein each automaton is configured to perform the steps of:
seeking a delegatee automaton to which to delegate a behavior;
delegate to the delagatee automaton to perform the behavior; and
listening for a deferral from the delegatee automaton upon completion of the behavior or generation of an error.

20. A method as claimed in claim 19, wherein each automaton can perform the step of determining the delegatee automaton by evaluating which other automaton can most efficiently perform the behavior

21. A method as claimed in claim 13, further including the step of receiving and/or transmitting with the controller, location data relating to dynamic attitude of the vehicle assembly or implement thereof.

22. A method as claimed in claim 13, wherein one of said automatons is configured to perform the steps of receiving a user input and performing supervisory behavior of another automaton.

23. A method as claimed in claim 21, wherein the other automaton is configured to perform the step of processing an input signal to generate an output signal.

24. A controller for controlling the behavior of a vehicle assembly, the controller including:
at least one processor coupled to ports for connecting to at least one sensor assembly and at least one actuator assembly of the vehicle assembly;
memory containing a software product including computer readable instructions for execution by the processor so as to define a plurality of automatons for performing respective behaviors to control the vehicle assembly;
an accepting interface for accepting requests from another automaton;
a requesting interface for making requests to another automaton;
a knowledge input for receiving a behavioral definition for affecting the behavior of the automaton;
a data input for receiving input data;
a data output for sending output data;
a requesting interface located at each automaton adapted for making a request to a delegatee automaton;
said requesting interface being configured to seek the delegatee automaton to which to delegate a behavior, delegate to the delagatee automaton to perform the behavior, and listen for a deferral from the delegatee automaton upon completion of the behavior or generation of an error
a storage device defining a register of possible behaviors, said storage device being located either onboard the controller or external to the controller and connected to the controller via a network, each automaton able to access said register to determine the delegatee automaton by evaluating which other automaton can most efficiently perform the behavior;
a memory resident utility program that loads and remains in random access memory (RAM) for instant availability when required;
said memory resident utility program adapted for delivering delegation commands to each automaton connected to the network and responding to delegation commands received from the delegating automaton.

25. A controller as claimed in claim 24, wherein the vehicle assembly includes a vehicle and an implement coupled to the vehicle.
